(19) United States
(12) Patent Application Publication
(10) Pub. No.: US 2004/0247168 A1
(43) Pub. Date: Dec. 9, 2004

(54) System and method for automatic selection of templates for image-based fraud detection

(76) Inventors: David A. Pintsov, San Diego, CA (US); Grigori Nepomniachtchi, San Diego, CA (US)

Correspondence Address: LUCE, FORWARD, HAMILTON & SCRIPPS LLP, 11988 EL CAMINO REAL, SUITE 200, SAN DIEGO, CA, 92130, US

(21) Appl. No.: 10/799,871

(22) Filed: Mar. 12, 2004

Related U.S. Application Data
(63) Continuation-in-part of application No. 09/586,724, filed on Jun. 5, 2000, now abandoned.

(51) Int. Cl. G06K 9/00; G06K 9/62

(52) U.S. Cl. 382/137; 382/209

(57) ABSTRACT

The present invention provides a system and method of automatically selecting check templates for image-based fraud detection including the steps of presenting a check image from an account, matching the check image against a series of known check templates from the account, producing confidence scores corresponding to the degree of similarity of the check image compared to each check template and matching the confidence scores with a predetermined high similarity threshold and a predetermined low similarity threshold.

### REFERENCE TO RELATED APPLICATIONS

This application is a Continuation-in-Part of U.S. patent application Ser. No. 09/586,724, filed Jun. 5, 2000, and is incorporated herein by reference in its entirety.

### FIELD OF THE INVENTION

This invention relates to automated document processing, and more particularly to automatic processing of financial documents involving image-based fraud detection.

### BACKGROUND OF THE INVENTION

In general, financial institutions are mechanizing clerical processing such as check processing by printing financial documents, such as account numbers and bank routing numbers, with a special ink which contains iron oxide. The special ink is used to form magnetic ink characters which may be read by both a human and a machine. Image-based check processing systems play a crucial role in check fraud detection software programs by extracting and verifying various check features that can be found on the check image. In order to be verifiable, an image feature should be either consistent across all check images from the same account, or cross-verifiable against another feature on the same check.

Data printed in magnetic ink on the financial documents is commonly referred to as magnetic ink character recognition (MICR) data. When a check is received at a bank for processing, the monetary amount of a typical check is written, for example, by a customer in plain or nonmagnetic ink. Part of the general, routine processing of the check requires that the monetary amount of the check be printed thereon in magnetic ink, thereby making it part of the MICR data on the check.

Check fraud is one of the largest challenges facing financial institutions today. Advances in counterfeiting technology has made it increasingly easy to create realistic counterfeit checks used to defraud banks and other businesses. Conventional methods of reducing check fraud include providing watermarks on the checks, fingerprinting non-customers that seek to cash checks, positive pay systems and reverse positive pay systems.

Positive pay systems feature methods in which the bank and its customers work together to detect check fraud by identifying items presented for payment that the customers did not issue. For example, each day the customers may electronically transmit to the bank a list of all checks issued on that day. In response, the bank verifies each check received for payment against the list and rejects checks not appearing on the customer lists. With reverse positive pay systems, each bank customer maintains a list of checks issued and informs the bank which checks match its internal information.

Although the above-identified check fraud security systems have been somewhat effective in deterring check fraud, they suffer from a multiplicity off drawbacks. For example, these systems are generally very slow such that a check usually takes several days to clear. In addition, most existing check fraud systems are too expensive for small companies.

In view of the above drawbacks, there exists a need for a system and method of image-based fraud detection for checking the authenticity of automatically extractible image features on a financial document such as a check.

### SUMMARY OF THE INVENTION

The present invention provides a system and method of image-based fraud detection for checking the authenticity of automatically extractible image features on a financial document such as a check. The system and method preferably are implemented using computer software programs comprising machine readable instructions for detecting fraudulent checks and verifying non-fraudulent checks. According to a preferred embodiment, the check authenticity test may be employed, wherein the automatically extractible image features (including MICR data) are lifted from the financial documents. Advantageously, the system and method of the present invention limit the number of templates for this test while not increasing the incidence of false positive results.

The present invention preferably involves the automatic processing of all financial documents. Documents containing mechanically (automatically) readable MICR information are processed as normal. Those documents without MICR information, or containing the MICR information that cannot be read are scanned to create an electronic image of the document. The electronic image of the document is subsequently automatically analyzed to provide the information as of the type of document (such as credit or debit) and the location and the value of the information of interest such as account numbers or amounts. This is accomplished by either automatically matching the automatically extracted document layout to a number of predefined document templates (those being documents in circulation in a particular institution and only those) or automatically identifying words present in the document (such as ticket, cash-in, cash-out, deposit, etc.). Once the identification of the document is accomplished, the system proceeds to automatically lift the data of interest from the image of the document.

One aspect of the present invention involves a method of automatically selecting check templates for image-based fraud detection, including the steps of presenting a check image from an account, matching the check image against a series of known check templates from the account and producing confidence scores corresponding to the degree of similarity of the check image compared to each check template. According to some embodiments, the method further includes the steps of matching the confidence scores with a predetermined high similarity threshold and a predetermined low similarity threshold. Check are positively identified as belonging to a specific check template group if the corresponding confidence score is above the predetermined high similarity threshold. A new check template is created if the confidence score is below the predetermined low similarity threshold.

Another aspect of the present invention involves a method of applying a partial layout comparison to the image and the closest matching template if the confidence score is above the low similarity threshold, but below the high similarity threshold. The method further comprising the steps of providing results of the partial layout comparison including a list of image parts and a corresponding confidence score for each image part and creating one or more exclusion zones corresponding to image parts that exhibit a low confidence score. Such exclusion zones are only created if a majority of the image parts exhibiting a low confidence score may be combined into a single, relatively small exclusion zone.

A further aspect of the present invention involves a computer program for automatically selecting check templates for image-based fraud detection, including machine readable instructions for matching a check image against a series of known check templates, producing confidence scores corresponding to the degree of similarity of the check image compared to each check template and matching the confidence scores with a predetermined high similarity threshold and a predetermined low similarity threshold. The computer program may additionally include machine readable instructions for positively identifying the check image if a confidence score is above the predetermined high similarity threshold, creating a new check template corresponding to the check image if the confidence score is below the predetermined low similarity threshold and applying the partial layout comparison to the check image and the closest matching check template if the confidence score is above the low similarity threshold and below the high similarity threshold.

### BRIEF DESCRIPTION OF THE DRAWINGS

These and other features and advantages of the invention will become more apparent upon reading the following detailed description and upon reference to the accompanying drawings.

FIG. 1 illustrates a check having magnetic ink as used in an embodiment of the present invention.

FIG. 2 is a flowchart of the automated check processing system using the MICR reader.

FIG. 3 illustrates a form that may be used in the automated check processing according to the present invention.

FIG. 4 is a flowchart of the automated check processing system including the identification of non-MICR documents according to an embodiment of the present invention;

FIG. 5 is a chart that illustrates types of consistent check image features;

FIG. 6 is a chart that illustrates types of cross-verifiable check image features;

FIG. 7 is a chart that illustrates types of automatically extractible check image features;

FIG. 8 illustrates a check that may be processed using the system and method of the present invention;

FIG. 9 illustrates a check having a date stamp that may be processed using the system and method of the present invention; and

FIG. 10 is a flowchart of a method of fraud detection in accordance with the principles of the present invention.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

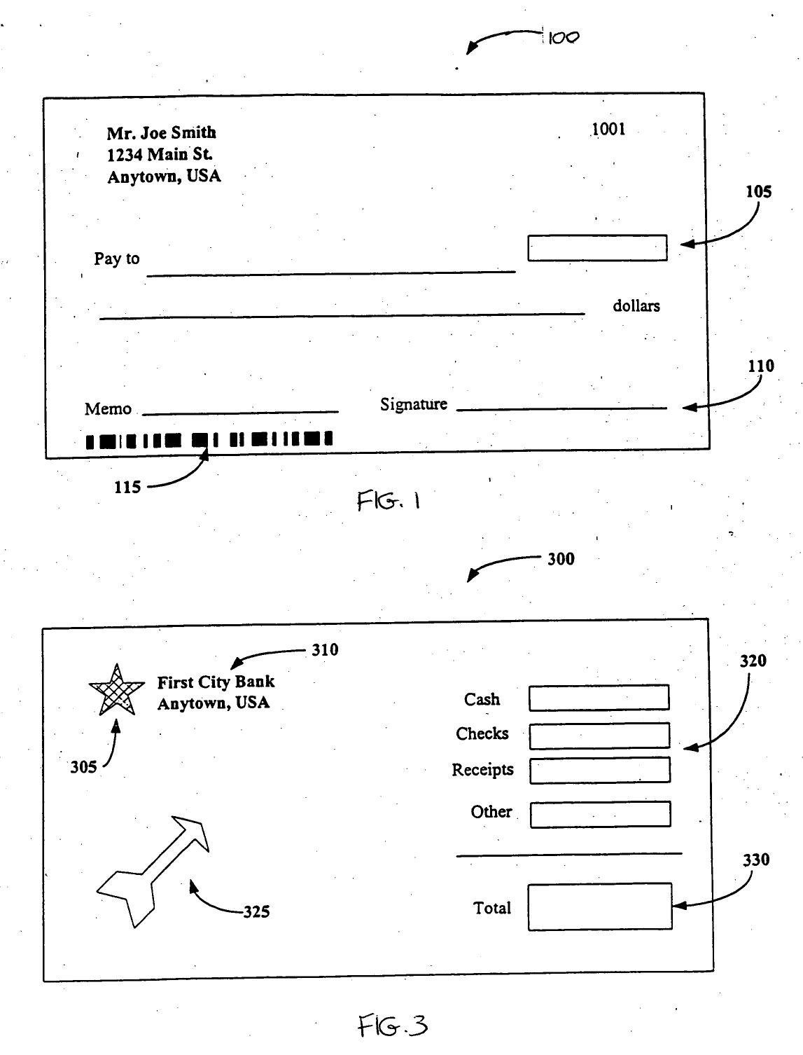

The present invention allows automated processing of documents containing MICR information in addition to documents without MICR information. FIG. 1 shows a typical financial document, a check 100, which undergoes automated processing. The check 100 includes an amount field 105, a signature field 110, and MICR information 105. After the completed check 100 is received by a financial institution, the check 100 is processed to ensure the proper amount of money is debited from the proper account.

The MICR information 115 may include the routing number of the financial institution, the account number, and the amount of the check 100. The MICR information 115 is printed using magnetic ink in a character format that may be read by both a machine and a human. The MICR information 115 allows the check 100 to be processed automatically.

The location of the fields in the check 100 is determined by banking regulations. These regulations ensure, for example, that the amount field 105 and the MICR information 115 are in the same location for each check 100 regardless of which institution issued the check 100. By regulating the location of this information, automated systems can be used to process the checks 100.

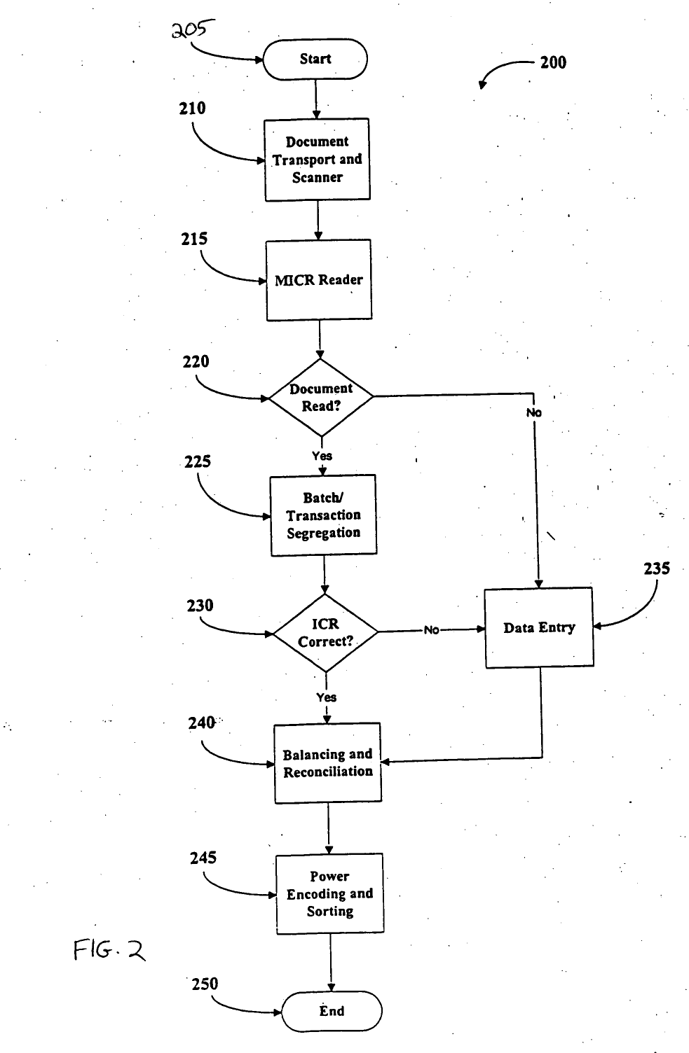

An automated document processing system 200 used to process checks 100 and other documents such as shown in FIG. 2. The document processing system 200 begins at a start state 205. Proceeding to state 210, the system 200 loads the items (checks, and other documents) into an automatic document transport. The automatic document transport scans each of the items and can provide electronic images of each of the items. The documents are also conveyed through the system 200 using the document transport.

Proceeding to state 215, the system 200 sends the documents to the MICR reader. Although shown as separate items, the MICR reader may be incorporated within the document transport and scanner. The MICR reader detects the pre-encoded magnetic ink character recognition code on the documents and depending on the MICR information, sorts the documents into a variety of subsets. The subsets may include, among others, debits and credits.

Proceeding to state 220, the system 200 determines if all of the documents have been read by the MICR reader. Documents may be rejected by the MICR reader for a variety of reasons, including missing MICR information 115 or distorted MICR information 115. In addition to the checks, the system 200 may be processing documents that do not include MICR information.

For the documents that were not read by the MICR reader, the system proceeds along the NO branch to state 235. In state 235, the data from these documents is entered into the system. The data is typically manually entered into the system. The entire processing system 200 is delayed until the data from the rejected documents is entered into the system. Although automated data entry systems are known in the art, there is always a manual component involved with the rejected items. This manual component is responsible for the limitations of the system 200.

Returning to state 220, the documents that are successfully read by the MICR reader proceed along the YES branch to state 225. In state 225, the documents undergo a batch segregation and a transaction segregation. Each document is either a debit (typically checks and cash-in documents) or a credit (deposit tickets or various types and cash-out documents). The batch segregation breaks a batch consisting of several transactions into its constituent transactions. Transaction segregation divides the transactions into their constituent debits and credits. This step is necessary since a transaction is in balance only if the sum of debits is equal to the sum of credits.

Proceeding to state 230, the system determines if any errors have been made in the magnetic character recognition. These errors may include an inaccurate account number, incorrect routing number or the like. If the system 200 is not able to verify all the information read by the MICR reader, the system 200 indicates an error in reading the document. Any document flagged as containing an error is sent to state 235 for manual data entry.

Once all the documents are verified as accurate either from the MICR reader or after manual data entry in state 235, the system 200 proceeds to state 240. In state 240, the documents are balanced and reconciled. During balancing and reconciling, the system 200 ensures that the total amount of debits equals the total amount of credits.

Proceeding to state 245, the documents are sent to the power encoder and sorter. Power encoding prints the amount of the item on the document using the magnetic ink.

The power encoding allows the document to be read magnetically during subsequent processing. Sorting separates the documents drawn on the institution processing checks from the checks drawn on other institutions so that the latter can be presented to those institutions for payment. The system then terminates in end state 250.

In addition to checks 100 that have predetermined field locations, the automated document processing system 200 may attempt to process other types of documents. These documents include deposit items, cash-in and cash-out documents and various credit and debit type documents. These documents are not governed by banking regulations and frequently do not possess any MICR encoding. Further, the field locations may vary from document to document. This makes it difficult for an automated system to process these documents without manual intervention.

A sample document 300 that may need processing is shown in FIG. 3. The document 300 may include a variety of fields including a logo 305, institution information 310, work fields 320, an institutional graphic 325, and a total field 330. Each document 300 may contain some or all of these fields, in addition to a variety of other fields. Because of the large number and unknown locations of potential fields, automated processing becomes difficult.

One embodiment of the present invention creates a template of each document 300 that may be processed in the automated system. The template includes information about the unique layout of document 300 that allows the system to identify and read the document 300. The system can then search the document for distinctive features such as the logo 305 or graphic 325, or a particular pattern of horizontal or vertical lines. After these distinctive features are identified, the document 300 is matched with the appropriate template. The template is then used to identify the location on the document to look for the information that is desired during processing. Once the location of the information is known, the information may be read automatically using optical character recognition (OCR) or any other technique known in the art. The template system may even compensate for distortions in the document due to feeding errors, or other sources of image distortions. The QuickFX™ program available from Mitek System, Inc., of San Diego, Calif., provides an embodiment of the document identification system described above.

In addition to identification of documents by distinctive layouts it may become necessary to identify documents by content, typically by words that are present in the documents. For example, the documents may have identical layouts but differ only by words “cash-in” and “cash-out.” In this case, an enhanced document processing system locates the words “cash-in” or “cash-out” and uses them as unique document identifiers.

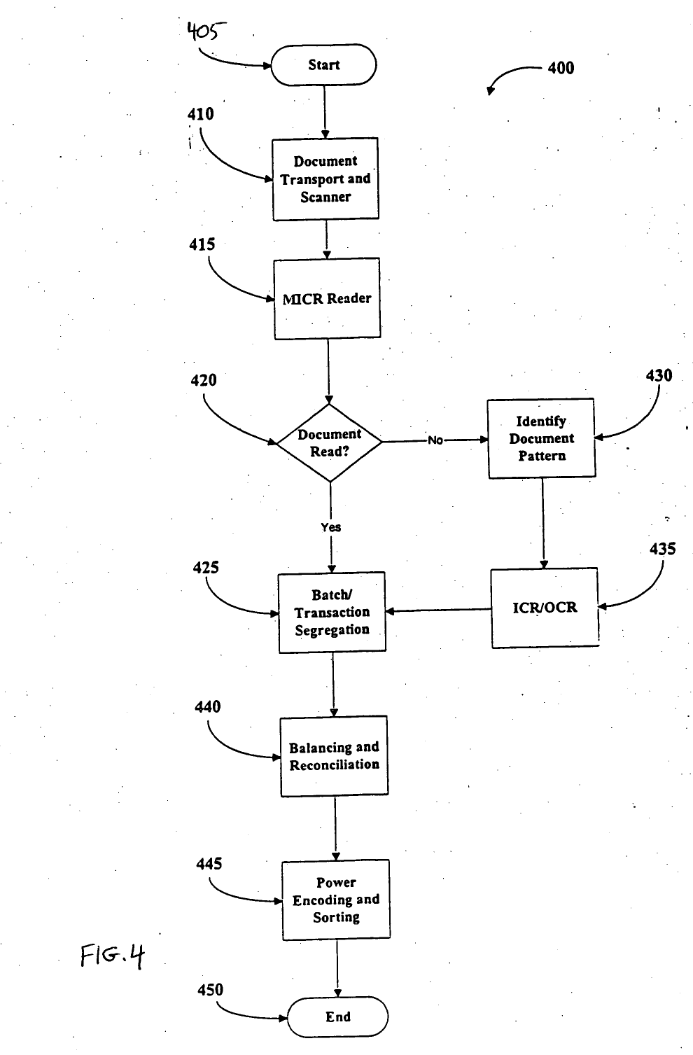

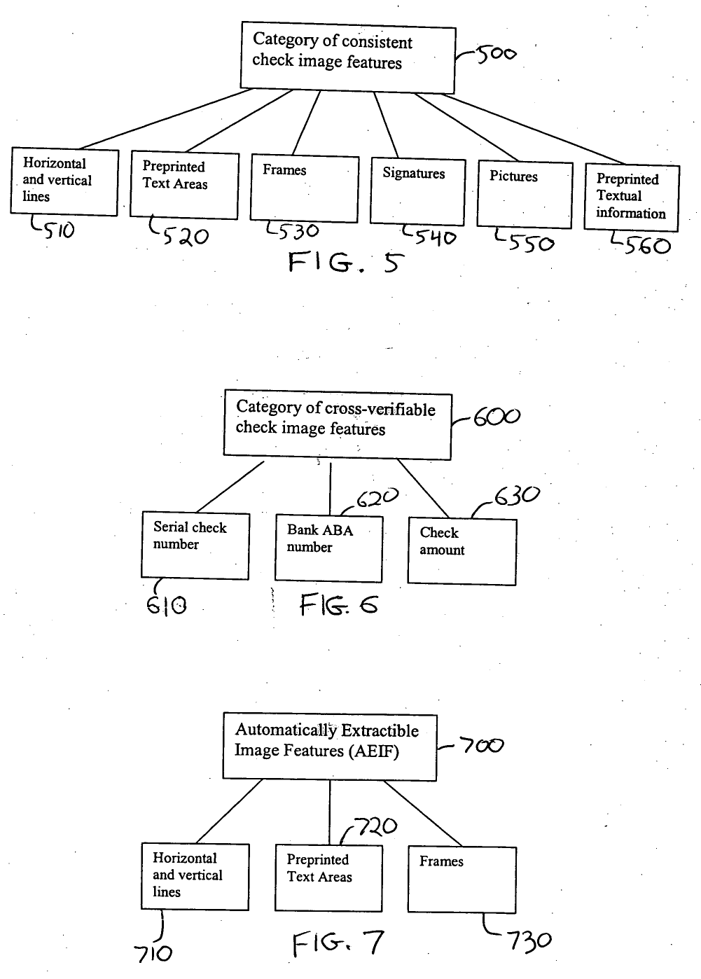

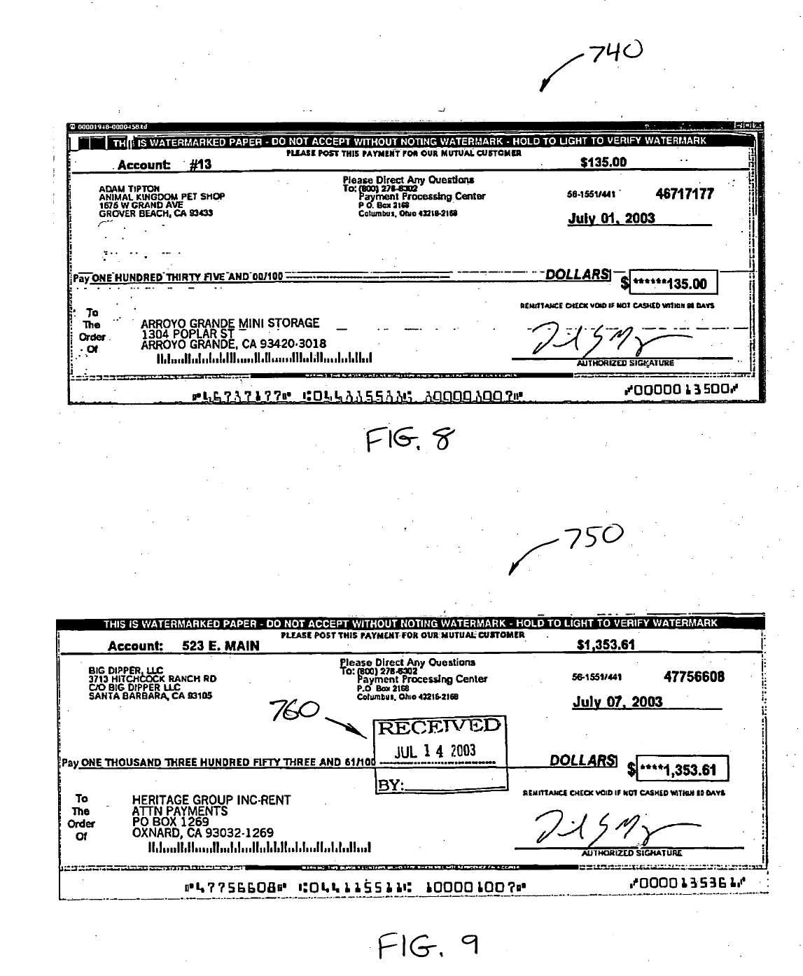

An enhanced document processing system 400 used to process checks 100 and other documents using the document identification system is shown in FIG. 4. The document processing system 400 begins at a start state 405. Proceeding to state 410, the system 400 loads the checks, documents, and other items into an automatic document transport. The automatic document transport scans each of the items and can provide electronic images of each of the items. The documents are also conveyed through the system 400 using the document transport.

Proceeding to state 415, the system 400 sends the documents to the MICR reader. As described above, the MICR reader detects the pre-encoded magnetic ink character recognition code on the documents and depending on the MICR information, sorts the documents into a variety of subsets. The subsets may include, among others, debits and credits.

Proceeding to state 420, the system 400 determines if all of the documents have been read by the MICR reader. For the documents that were not read by the MICR reader, the system proceeds along the NO branch to state 430. In state 430, the documents that were not read by the MICR reader are identified. Based on the document identification, each document is assigned to a template which includes information on the location of the fields of the document.

Proceeding to state 435, after the documents are identified, the necessary data is retrieved from the document. The data is retrieved automatically using character recognition, including optical character recognition (OCR) or intelligent character recognition (ICR). It is well known in the art to automatically obtain information from a known location, and any technique may be used without departing from the spirit of the invention. After all the data is read, the system 400 proceeds to state 425.

Returning to state 420, the documents that are successfully read by the MICR reader proceed along the YES branch to state 425. In state 425, both the documents read by the MICR reader and the documents processed through the automated identification process undergo a batch segregation and a transaction segregation. Each document is either a debit (typically checks and cash-in documents) or a credit (deposit tickets of various types and cash-out documents). The batch segregation breaks a batch consisting of several transactions into its constituent transactions. Transaction segregation divides the transactions into their constituent debits and credits. This step is necessary since a transaction is in balance only if the sum of debits is equal to the sum of credits.

Proceeding to state 440, the documents are balanced and reconciled. During balancing and reconciliation, the system 400 ensures that the total amount of debits equals the total amount of credits.

Proceeding to state 445, the documents are sent to the power encoder and sorter. Power encoding prints the amount of the item using the magnetic ink in a special font on the document. The power encoding allows the document to be read magnetically during subsequent processing. Sorting separates the documents drawn on the institution processing checks from the checks drawn on other institutions so that the latter can be presented to those institutions for payment. The sorting uses the routing number and bank number in the MICR information. The system then terminates in end state 450.

In accordance with an aspect of the present invention, an image-based fraud detection system and method will now be described with respect to FIGS. 5-10. The system and method preferably are implemented using a computer software program comprising machine readable instructions for detecting fraudulent checks and verifying non-fraudulent checks. As discussed above in the background of the invention section, an image feature should be either consistent across all check images from the same account, or cross-verifiable against another feature on the same check in order to be verifiable. It is hereby noted that the image-based fraud detection system and method may be used to verify other financial documents such as loan documents, and may additionally be used to verify non-financial documents.

Referring to FIG. 5, some substantially consistent check image features 500 include, but are not limited to: horizontal and vertical lines 510; preprinted text areas 520; frames 530; signatures 540; pictures 550 (e.g., logos and trademarks); and preprinted textual information 560 (e.g., name of owner, address, etc.). Of course, as would be understood by those of ordinary skill in the art, some checks may feature additional consistent image features without departing from the scope of the present invention.

According to a preferred embodiment, an automated document processing system 200, such as described with respect to FIG. 2, may be used to independently extract each of the consistent check image features and match them against a template. To compare the positions of lines, preprinted text areas and frames, one can use patterns of the same features found on any check image chosen from the same account having the same layout. This technique of feature comparison maybe referred to as form identification. Signature verification may also be employed as part of the fraud detection system and any valid signature of the same person(s) may be used as part of a template. Further, any image of the same picture(s) may be used as part of a template for what is known as pattern matching. Preprinted textual information, for example the contents of one or more text strings, may be used as part of a template for performing a text string comparison. Optionally, the template may also include an approximate location of the text string.

Referring to FIG. 6, some cross-verifiable check image features 600 include, but are not limited to: serial check numbers 610; bank ABA numbers 620; and check amounts 630. Each of these features can be independently extracted from two locations within the check image (one is the check MICR-line) and then matched against each other. Thus, a template is unnecessary to verify the cross-verifiable check image features.

Referring to FIG. 7, of the six consistent check image features disclosed with respect to FIG. 5, three of these check image features may additionally be classified as automatically extractible image features (AEIF) 700. The AEIFs include horizontal and vertical lines 710, preprinted text areas 720 and frames 730. These features are automatically extractible from an image in that no additional information is required to locate the features. In addition, each of these feature can be represented by a set of respective locations within the image. According to some embodiments, the three types of AEIFs are combined into a single AEIF test, which preferably is automatically configured provided an AEIF template image. Advantageously, the AEIF test does not require any manual zone selection within the image.

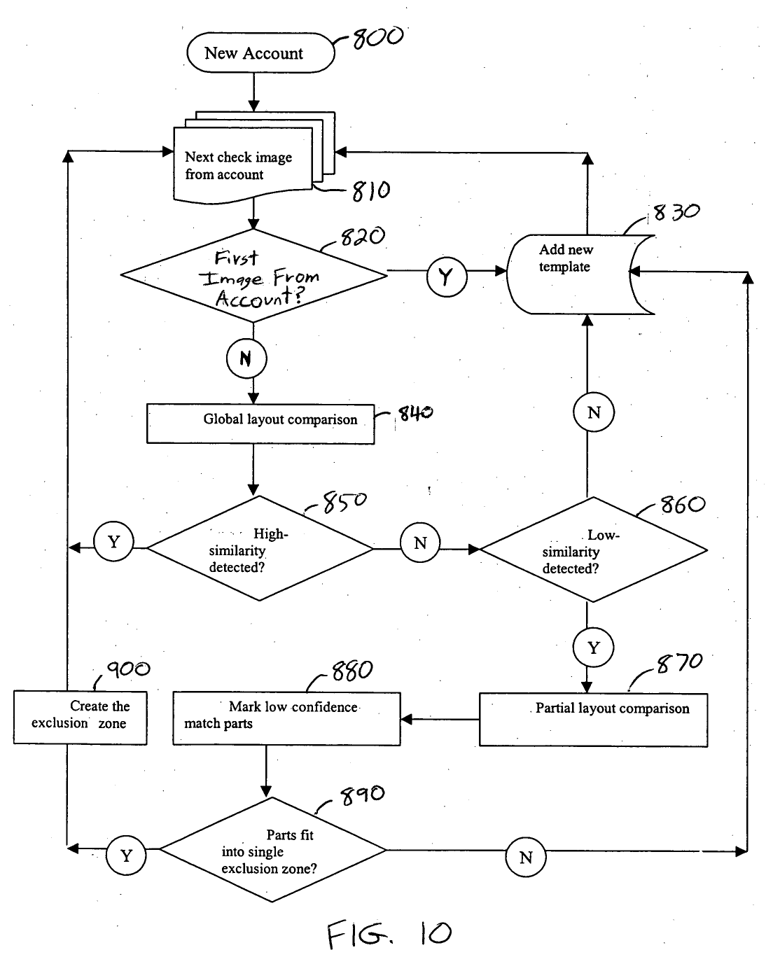

The presence of inconsistent image elements among checks from the same account and with the same overall layout typically requires the use of more than one AEIF template image stored in the application memory for the AEIF test. One example of inconsistent image elements is date stamps. FIG. 8 depicts an image of a check 740 without a stamp. The AEIFs (i.e., horizontal and vertical lines, pre-printed text location and frames) are substantially consistent among all checks from the same account. FIG. 9 depicts an image of a check 750 having a stamp 760. The stamp 760 introduces the following inconsistent elements into the AEIFs: (1) an extra frame; (2) four lines; and (3) several machine printed words. Advantageously, the present invention avoids the necessity to keep extra AEIF templates to account for inconsistent image elements such as date stamps. In most instances, only one AEIF template is required per different layout within the same bank account despite such inconsistencies.

One part of the AEIF test pertains to automatic template selection, which maybe carried out using a form identification engine, wherein incoming check images are compared with one or more known account templates. When an incoming check image is not recognized by the form identification engine, a new template is created corresponding to the incoming check image. Thus, the number of account templates increases by one each time the system is presented with a check having a new layout. Preferably, the automatic template selection feature of the present invention is able to distinguish between a new layout and previously known layout having an inconsistent image element such as a date stamp.

The present invention contemplates several methods of verifying whether an incoming check image, which is not recognized by the form identification engine, is indeed legitimate. In one embodiment, when a fraudulent check enters the system, the fraudulent check image is entered as a new template. When a legitimate check corresponding to the fraudulent check enters the system, the inconsistencies between the checks are discovered by the system such that a person may verify the legitimate check and enter it into the template in place of the fraudulent check. According to other embodiments, all incoming check that are not recognized by the system are flagged to be verified by a person. Further embodiments contemplate that the first group of check images (e.g., the first 100 checks) from a new account are flagged for human verification. Still other embodiments contemplate the use of historical check images to verify incoming check images that are not recognized by the system.

In operation, the form identification engine is used to compare a check image with the template image and produce a corresponding confidence score that reflects the similarity between image layouts. According to a preferred embodiment, the confidence score is measured on a scale from 0 to 1000, wherein a score of 0 equates to no similar features and a score of 1000 equates to identical features. For check images from the same account, automatic template selection may be set up to include a predetermined high similarity threshold and a predetermined low similarity threshold. According to some embodiments, a confidence score of 750 represents the predetermined high similarity threshold and a confidence score of 550 represents the predetermined low similarity threshold.

According to an aspect of the present invention, the form identification engine can perform different types of image comparisons, such as including global comparisons, local comparisons and global comparisons with exclusions. When the form identification engine performs a global comparison of image layouts, all of the check image features are taken into account. On the other hand, when the form identification engine performs a local comparison of the image layouts, only a set of particular image features (e.g., logos and signatures) are taken into account. As a further alternative, when the form identification engine performs a global comparison with exclusions, all of the image features minus certain exclusion zones are taken into account.

A method of automatically selecting templates for image-based fraud detection will now be described with respect to FIG. 10. The initial step of this method involves selecting a new account having an empty set of check image templates (step 800). The next step involves presenting a check image from the account to the software (step 810). At step 820, the software checks whether the image is the first image from the account. If it is the first image, the software adds a new image template to the account (step 830) and proceeds to step 810 to consider the next check image. If the image is not the first image, the method proceeds to step 840, wherein the software performs a global layout comparison, wherein the image is matched against all known templates from the account. The software only performs a true global comparison of the image layouts if no exclusion zones are defined. If one or more exclusion zones are defined, the software performs a global comparison of the image layouts excluding the exclusion zones.

At step 850, the software matches the confidence score of the comparison with a predetermined high similarity threshold (e.g., 750). If the confidence score is above the predetermined high similarity threshold, the check is positively identified and the method proceeds to step 810 for analysis of the next image. On the other hand, if the confidence score is not above the predetermined high similarity threshold, the method proceeds to step 860, wherein the software matches the confidence score of the comparison with a predetermined low similarity threshold (e.g., 550). If the confidence score is below the predetermined low similarity threshold, the software determines that the check belongs to a previously unknown check stock, and a new template is added corresponding to the new check image (step 830). However, if the confidence score is above the low similarity threshold, the method proceeds to step 870, wherein the software applies a partial layout comparison to the image and the closest template.

In step 880, the software provides the outcome of the partial layout comparison including a list of image parts along with a corresponding confidence score for each part. The results will typically include a high-confidence match (HCM) between some of the parts and a low-confidence match (LCM) between the remaining parts. The results should include the detection and marking of at least one LCM part. Otherwise, the overall layout match would have been above the high similarity threshold in step 850. In step 890, the software examines the number, location and the total area of the LCM parts and determines whether the majority (or all) of these parts may be embedded into a single, relatively small zone. If not, the software adds the template image to the account (step 830) and proceeds to step 810. However, if the majority of the LCM parts can be embedded into a single, relatively small exclusion zone, the method proceeds to step 900, wherein the software marks the union of the LCM parts as an exclusion zone. This exclusion zone will be excluded from future image feature comparisons. After creation of the exclusion zone, the method proceeds back to step 810.

Thus, it is seen that a automatically selecting templates for image-based fraud detection is provided. One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

What is claimed is:

1. A method of automatically selecting document templates, comprising the steps of:
presenting a document image from an account;
matching the document image against a series of known check templates from the account; and
producing confidence scores corresponding to the degree of similarity of the document image compared to each document template.

2. The method of claim 1, further comprising the step of matching the confidence scores with a predetermined high similarity threshold.

3. The method of claim 2, further comprising the step of positively identifying the document image if a confidence score is above the predetermined high similarity threshold.

4. The method of claim 1, further comprising the step of matching the confidence score with a predetermined low similarity threshold.

5. The method of claim 4, further comprising the step of creating a new document template for the account corresponding to the document image if the confidence score is below the predetermined low similarity threshold.

6. The method of claim 4, further comprising the step of applying a partial layout comparison to the image and the closest matching template if the confidence score is above the low similarity threshold.

7. The method of claim 6, further comprising the step of providing results of the partial layout comparison including a list of image parts and a corresponding confidence score for each image part.

8. The method of claim 7, further comprising the step of creating one or more exclusion zones corresponding to image parts that exhibit a low confidence score.

9. The method of claim 1, wherein the document is a check.

10. A method of automatically selecting check templates, comprising the steps of:
presenting a check image from an account;
matching the check image against a series of known check templates from the account;
producing confidence scores corresponding to the degree of similarity of the check image compared to each check template;
matching the confidence scores with a predetermined high similarity threshold and a predetermined low similarity threshold.

11. The method of claim 10, further comprising the step of positively identifying the check image if a confidence score is above the predetermined high similarity threshold.

12. The method of claim 10, further comprising the step of creating a new check template for the account corresponding to the check image if the confidence score is below the predetermined low similarity threshold.

13. The method of claim 10, further comprising the step of applying a partial layout comparison to the image and the closest matching template if the confidence score is above the low similarity threshold and below the predetermined high similarity threshold.

14. The method of claim 13, further comprising the step of providing results of the partial layout comparison including a list of image parts and a corresponding confidence score for each image part.

15. The method of claim 14, further comprising the step of creating one or more exclusion zones corresponding to image parts that exhibit a low confidence score.

16. A computer program for automatically selecting document templates, comprising:
machine readable instructions for matching a document image against a series of known document templates;
machine readable instructions for producing confidence scores corresponding to the degree of similarity of the document image compared to each document template; and
machine readable instructions for matching the confidence scores with a predetermined high similarity threshold and a predetermined low similarity threshold.

17. The computer program of claim 16, further comprising machine readable instructions for positively identifying the document image if a confidence score is above the predetermined high similarity threshold.

18. The computer program of claim 16, further comprising machine readable instructions for creating a new document template corresponding to the document image if the confidence score is below the predetermined low similarity threshold.

19. The computer program of claim 16, further comprising machine readable instructions for applying a partial layout comparison to the document image and the closest matching document template if the confidence score is above the low similarity threshold and below the high similarity threshold.

20. The computer program of claim 19, further comprising machine readable instructions for providing results of the partial layout comparison including a list of image parts and a corresponding confidence score for each image part.

21. The computer program of claim 20, further comprising machine readable instructions for creating one or more exclusion zones corresponding to image parts that exhibit a low confidence score.

22. The computer program of claim 16, wherein the document is a check.
